(19) United States
(12) Patent Application Publication
(10) Pub. No.: US 2022/0089409 A1
(43) Pub. Date: Mar. 24, 2022

(54) METHOD FOR GENERATING A REPRESENTATION OF AN ELEVATOR ROPE, A CONTROL UNIT AND A COMPUTER PROGRAM PRODUCT FOR PERFORMING THE SAME

(71) Applicant: KONE Corporation, Helsinki (FI)

(72) Inventors: Petteri Valjus, Helsinki (FI); Jouko Kinnari, Helsinki (FI); Risto Hyypiö, Helsinki (FI); Pekka Suopajärvi, Helsinki (FI); Teemu Sipola, Helsinki (FI)

(73) Assignee: KONE Corporation, Helsinki (FI)

(21) Appl. No.: 17/543,086

(22) Filed: Dec. 6, 2021

Related U.S. Application Data
(63) Continuation of application No. PCT/FI2019/050588, filed on Aug. 16, 2019.

(51) Int. Cl. B66B 7/12; G06T 11/00; G01N 21/88; G01N 21/952

(52) U.S. Cl. CPC B66B 7/1238; G01N 21/952; G01N 21/8851; G06T 11/00

(57) ABSTRACT

A method for generating a representation of an elevator rope includes determining a first edge and a second edge of the elevator rope from measurement data obtained from consecutive measurement instances; and generating a representation of the elevator rope by combining the measurement data of the consecutive measurement instances in accordance with the determined first edge of the elevator rope and the determined second edge of the elevator rope. Some aspects relate to a control unit and a computer program product.

### TECHNICAL FIELD

The invention concerns in general the technical field of elevators. More particularly, the invention concerns rope monitoring solution for elevator systems.

### BACKGROUND

Elevator safety is one of the most important matters to ensure. The elevator systems comprise ropes, such as suspension ropes, over-speed governor ropes and compensation ropes, which are wearing parts having an estimated life-time and for this reason a condition of the ropes needs to be monitored for ensuring safe use of the elevator system and life-time predictability in question.

Typically, the ropes used in the elevator solutions now-a-days are stranded steel wire ropes. The ropes may be affected by corrosion, fatigue, wear, chemical attack as well as mechanical attack which all may cause damages to the ropes. The challenge in traditional ways of monitoring the condition of the elevator ropes is to decide so-called discard criteria for replacing a damaged rope with a new set of ropes. Especially, the decision-making, and especially an evaluation of the rope condition, has been time-consuming and inaccurate with the traditional methods, because it is based on a visible detection of broken wires and overall condition, like wear and excessive rusting of the rope. Beside of wire break detection, a change in rope diameter as well as a tolerance for tension need to be monitored.

In a document WO 2018/101296 Al it is described a solution for monitoring an elevator rope. The solution is based on using a plurality of cameras for imaging an entire circumference of a traveling elevator rope and the images taken with the cameras are brought to image processing means for detecting an abnormality in the elevator rope by analyzing the entire circumferential image created from a plurality of images taken with the plurality of cameras. The solution also comprises speed/position detecting device for providing information to be associated with the images in order to combine the plurality of images in an appropriate manner. However, the solution as introduced in the document is problematic in a sense that it is slow to use since combining the images and analyzing the combined image is time consuming as well as costly due to complex structure of the solution.

Hence, there is need to introduce alternative solutions which mitigate at least in part drawbacks of the existing solutions, and allow condition monitoring of elevator ropes in an efficient manner.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present an elevator rope monitoring device, a method, a computer program product and a system for monitoring an elevator rope.

The objects of the invention are reached by an elevator rope monitoring device, a method, a computer program product and a system for monitoring an elevator rope as defined by the respective independent claims.

According to a first aspect, a method for generating a representation of an elevator rope is provided, the method comprising: determining a first edge and a second edge of the elevator rope from a measurement data obtained from consecutive measurement instances; generating a representation of the elevator rope by combining the measurement data of the consecutive measurement instances in accordance with the determined first edge of the elevator rope and the determined second edge of the elevator rope.

The measurement data may be obtained simultaneously from all pixels of a sensor.

Further, the determination may be performed by one of a following: analyzing the measurement data by starting from the measurement data read from at least one pixel residing in a center of the sensor and continuing an analysis pixel-by-pixel to an outward direction of the pixels in the sensor; or analyzing the measurement data by starting from the measurement data read from at least one pixel residing outmost of the sensor and continuing the analysis pixel-by-pixel to an inward direction of the pixels in the sensor.

A generation of the representation of the elevator rope may comprise a generation of a peak/valley representation of the elevator rope.

Moreover, the method may further comprise: determining a width of the elevator rope based on a distance between the determined first edge of the elevator rope and the second edge of the elevator rope. The width of the elevator rope may be determined from the peak/valley representation by determining a peak of the first edge and a peak of the second edge at a same measurement instant having a largest distance over a predetermined length of the elevator rope as the width of the elevator rope.

The representation of the elevator rope may be generated in a frequency domain by applying a Fourier transform of the measurement time with respect to width data. The method may further comprise: identifying at least one rising lower frequency component from the representation of the elevator rope in the frequency domain, and in response to an identification of at least one rising lower frequency component generating an indication on at least one loose strand in the elevator rope.

The method may further comprise estimating a measurement position of the elevator rope on a basis of a peak/valley representation of the elevator rope.

According to a second aspect, a control unit for generating a representation of an elevator rope, the control unit comprising: at least one processor; at least one memory including computer program code; wherein the at least one memory and the computer program code configured to, with the at least one processor, cause the control unit to perform: determine a first edge and a second edge of the elevator rope from a measurement data obtained from consecutive measurement instances; generate a representation of the elevator rope by combining the measurement data of the consecutive measurement instances in accordance with the determined first edge of the elevator rope and the determined second edge of the elevator rope.

The control unit may be arranged to obtain the measurement data simultaneously from all pixels of a sensor.

Further, the control unit may be arranged to perform the determination by one of a following: analyzing the measurement data by starting from the measurement data read from at least one pixel residing in a center of the sensor and continuing an analysis pixel-by-pixel to an outward direction of the pixels in the sensor; or analyzing the measurement data by starting from the measurement data read from at least one pixel residing outmost of the sensor and continuing the analysis pixel-by-pixel to an inward direction of the pixels in the sensor.

The control unit may be arranged to generate the representation of the elevator rope as a peak/valley representation of the elevator rope.

Moreover, the control unit may further be caused to perform: determine a width of the elevator rope based on a distance between the determined first edge of the elevator rope and the second edge of the elevator rope. For example, the control unit may be arranged to determine the width of the elevator rope from the peak/valley representation by determining a peak of the first edge and a peak of the second edge at a same measurement instant having a largest distance over a predetermined length of the elevator rope as the width of the elevator rope.

The control unit may also be arranged to generate a representation of the elevator rope in a frequency domain by applying a Fourier transform of the measurement time with respect to width data. The control unit may further be caused to perform: identify at least one rising lower frequency component from the representation of the elevator rope in the frequency domain; and in response to an identification of at least one rising lower frequency component generate an indication on a loose strand in the elevator rope.

The control unit may further be caused to perform: estimate a measurement position of the elevator rope on a basis of a peak/valley representation of the elevator rope.

According to a third aspect, a computer program product for generating a representation of an elevator rope is provided, which computer program product, when executed by at least one processor, cause a control unit to perform the method as described in the foregoing description.

The expression “a number of” refers herein to any positive integer starting from one, e.g. to one, two, or three. The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator rope monitoring device as a block diagram.

FIG. 2 illustrates schematically an elevator system in which the invention may be applied to.

FIG. 3 illustrates schematically a source of electromagnetic radiation as a block diagram.

FIGS. 4A and 4B illustrate schematically some non-limiting examples of radiation apertures applicable in a context of the elevator rope monitoring device.

FIG. 5 illustrates schematically an example of a sensor side of the elevator rope monitoring device.

FIG. 6 illustrates schematically a representation of an elevator rope according to an embodiment of the invention.

FIG. 7 illustrates schematically an example of a method according to an embodiment of the invention.

FIG. 8 illustrates schematically an example of a control unit of an elevator rope monitoring device according to an embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

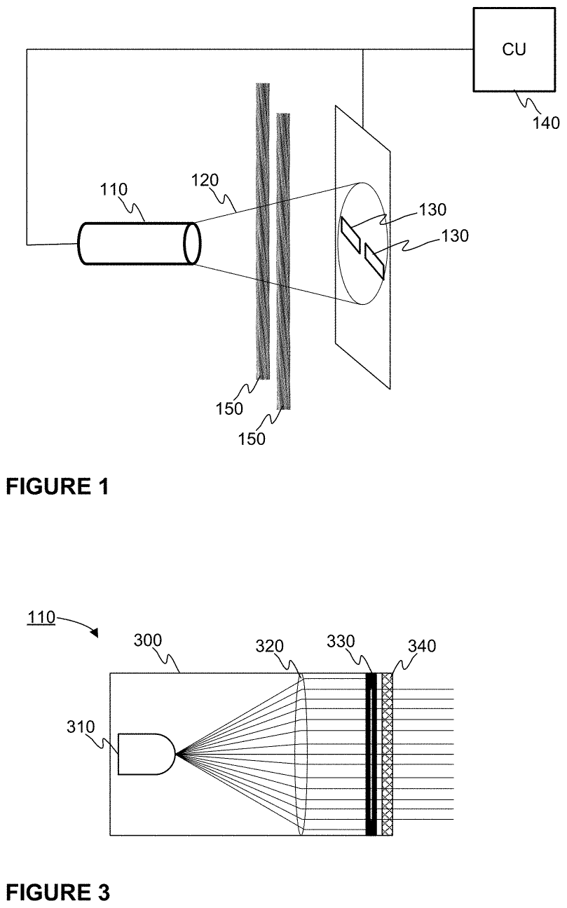

FIG. 1 schematically illustrates a block diagram of some components and/or entities of an arrangement forming an elevator rope monitoring device to depict an exemplifying framework for one or more embodiments of the present invention. The arrangement as schematically illustrated in FIG. 1 is suitable for generating measurement data for establishing a representation of an elevator rope as will be described. The arrangement may comprise a source of electromagnetic radiation 110 and at least one sensor 130 for receiving the electromagnetic radiation from the source of the electromagnetic radiation 110. In other words, the source of the electromagnetic radiation 110 may be arranged to emit a radiation beam 120. The elevator rope monitoring device is arranged so that at least one elevator rope 150 travels through the radiation beam 120 so that a projected image of at least a portion of the at least one rope 150 may be generated on the sensor 130. In the non-limiting example of FIG. 1 the elevator rope monitoring device is arranged to monitor two ropes for each of which a dedicated sensor 130 is arranged. The sensor 130 type is selected in accordance with the electromagnetic radiation generated by the source 110. Moreover, the arrangement may comprise a processing unit 140 which may be arranged to control of one or more entities of the elevator rope monitoring device. For example, the control unit 140 may be arranged to control of a generation of the radiation beam, e.g. by generating a control signal to the source of electromagnetic radiation 110, as well as reading of a measurement data from the at least one sensor 130 as well as analyzing the measurement data. Moreover, the measurement data and/or any analysis result of it may be sent to data center, e.g. implemented in a cloud network, for further use for preventive maintenance. The control unit 140 may be arranged to generate a representation of the elevator rope 150 from the measurement data received from the at least one sensor 130. For example, the representation of the elevator rope 150 may correspond to a data representing a portion of the elevator rope 150 or a representation of the elevator rope 150 as a function of the elevator rope 150 length along which the measurement data is generated. Moreover, the representation of the elevator rope 150 may allow an establishment of parameters, as a further representation of the elevator rope 150, and e.g. to be used for evaluating at least one characteristic of the rope through it. The mentioned entities, and other possible entities, may be communicatively coupled to each other with an applicable data bus. The data bus is preferably suitable for transferring data fast enough to monitor the condition of the elevator e.g. in a normal use speed of the elevator.

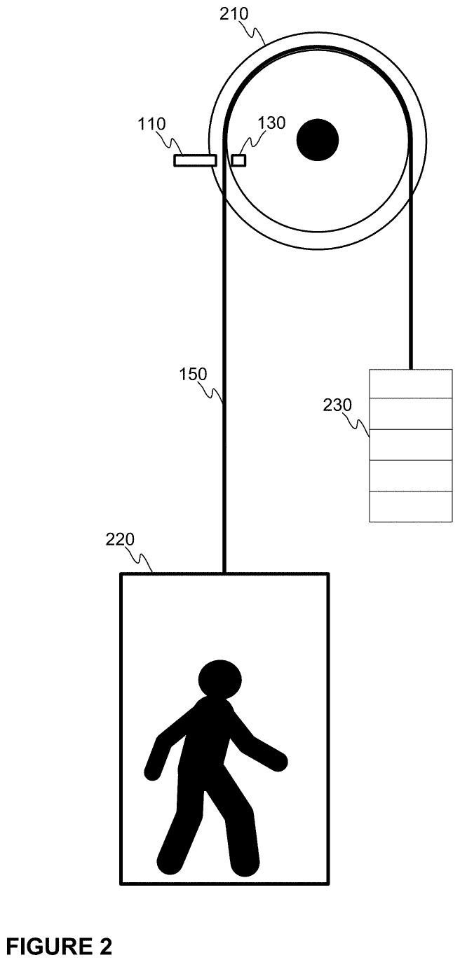

FIG. 2 schematically illustrates an elevator system into which an elevator rope monitoring device is installed to. The simplified elevator system comprises a traction sheave 210 over which a number of elevator ropes 150 may travel. The number of elevator ropes 150 connects an elevator car 220 and a counterweight 230. Hence, by providing power to the traction sheave with a hoisting machine (not shown in FIG. 2) it is possible to move the elevator car 220 in an elevator shaft between destination floors. As may be seen from FIG. 2 an advantageous location for mounting the elevator rope monitoring device, i.e. at least the source of electromagnetic radiation 110 and the at least one sensor 130, may be close to a traction sheave 210 ora deflecting pulley e.g. either in a machine room or in a shaft, or in case of overspeed governor use, close to pulley. This is because there a deviation of the at least one elevator rope 150 from its track is at minimum which improves, at least in part, the operation of the elevator rope monitoring device. Additionally, by mounting the elevator rope monitoring device, or at least the mentioned portions of it, as mentioned allows the monitoring of the elevator rope 150 in an efficient manner since most of the elevator rope then passes the monitoring device during an operation of the elevator. In other words, the implementation as schematically illustrated in FIG. 2 allows an online condition monitoring of the at least one elevator rope 150 during an operation of the elevator. The normal operation may comprise, but is not limited to, a normal elevator operation and a maintenance drive of the elevator. Further, if a monitoring of suspension ropes is implemented with the present solution, the sensor may be positioned in an applicable distance of diverting pulleys residing in an elevator car.

FIG. 3 schematically illustrates a block diagram of a source of electromagnetic radiation 110 according to an example embodiment. The source of electromagnetic radiation 110 of FIG. 3 illustrates some components and entities according to the example embodiment. According to the embodiment as schematically depicted in FIG. 3 the source of electromagnetic radiation 110 may comprise a casing 300 into which a radiator element 310 configured to emit radiation applied in the elevator rope monitoring device is arranged to. For example, the radiator element 310 may be a diode emitting electromagnetic radiation having a predetermined wavelength band. The emitted electromagnetic radiation may be taken in a beam form to a lens 320 comprising a number of lenses. The type of lens 320 may e.g. be selected so that it may collimate rays of the radiation originating from the radiation element 310 to substantially parallel rays. A non-limiting example of the lens 320 may be a convex collimation lens made of a silicate, plastic or glass, for example. The collimated radiation may be directed, by means of the lens 320 to a radiation aperture 330, also called as illumination aperture. The radiation aperture 330 is arranged to block at least a portion of the collimated radiation for generating a radiation beam of a desired format. According to an example embodiment such a radiation aperture 330 is applied in the source of electromagnetic radiation 110, which may generate at least one radiation beam having a linear form, i.e. a linear radiation beam is generated. For sake of clarity the linear radiation beam shall be understood as a planar beam. Moreover, in some example embodiments the source of electromagnetic radiation 110 may comprise a radiation window 340. The radiation window 340 is arranged to close the closing 300 and in that manner to protect the source of electromagnetic radiation from dirt. The radiation window may e.g. be made of glass through which the applied electromagnetic radiation, and, thus, the generated linear radiation beam may be output from the source 110 towards the at least one sensor 120.

Especially in example embodiments in which the electromagnetic radiation is in a range of wavelengths being so-called visible light it may be necessary to protect the radiation window 340 from dirt. In some embodiment a controllable protection cover for protecting the radiation window may be arranged on a surface of the radiation window 340 facing the at least one sensor 120. For example, the protection cover may be equipped with a transport device i.e. an actuator, such as with a solenoid, an electric motor or a servomotor, which may generate power for displacing the protection cover from the radiation window 340 at least in part e.g. in accordance with a control signal generated by the control unit 140. Alternatively or in addition, the protection of the radiation window 340 may be arranged so that there is arranged a number of detachable plastic protecting films stacked on top of each other on the radiation window 340. Hence, the detachable plastic protecting films may be removed, e.g. one at a time, so that dirty outmost layer may be removed by detaching the topmost film, and in that manner the elevator rope monitoring device may be maintained operative.

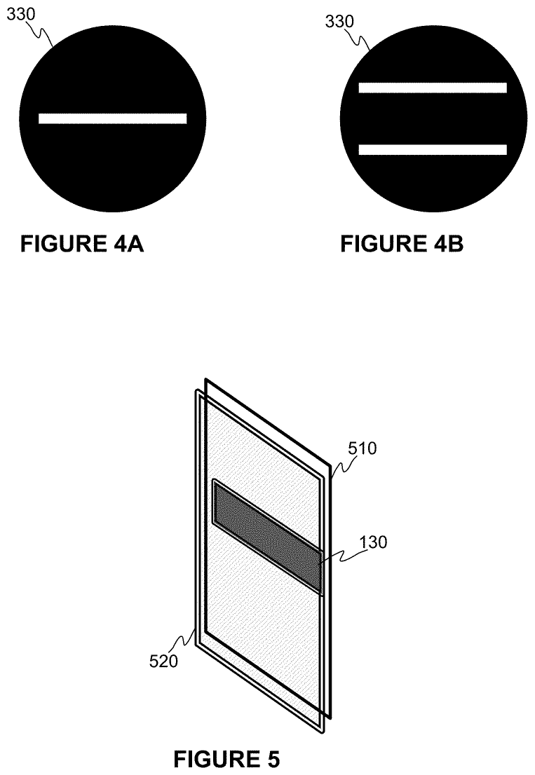

FIGS. 4A and 4B schematically illustrate some non-limiting examples of radiation apertures 330 which may be applied in the source of electromagnetic radiation 110 of the elevator rope monitoring device especially when the aim is to generate at least one linear radiation beam towards the at least one sensor 130. The radiation aperture 330 of FIG. 4A comprises one aperture, i.e. hole, whereas the radiation aperture 330 comprises two apertures for generating two linear radiation beams. Advantageously, the radiation aperture is mounted in the source 110 so that the generated linear radiation beam extends over a rope under monitoring so that the sensor 130 receives radiation passing the rope on the both sides. The radiation aperture is advantageously made of material being suitable to block at least part of the radiation received from the radiator element 310 through the collimation lens 320. For example, the radiation aperture may be made of steel.

An advantage of using the radiation aperture 330 is that especially in various example embodiments in which the electromagnetic radiation is visible light it is preferred to block at least part of the light to end up to the sensor side, because the light falling outside a detection area of the sensor causes degradation in a contrast of an image generated from the data obtainable from the sensor 130. Hence, the radiation aperture 330 as such is not an essential element but may be used in various example embodiments for improving a monitoring result of the device.

The source of electromagnetic radiation 110 may be arranged to generate any suitable electromagnetic radiation and the sensor 130 is selected accordingly. According to an example embodiment the electromagnetic radiation may be visible light, such as having a wavelength of about 380 to 740 nanometers. According to an advantageous embodiment the elevator rope monitoring device may be implemented so that the electromagnetic radiation is laser light. The laser light has known advantages, such as coherence, directionality, monochromatic, and high intensity, e.g. with respect to ordinary light, and for this reason it is suitable for measurement applications. Hence, the radiator element 310 may be selected accordingly. For example, the radiator element 310 may be an applicable laser diode, such a single mode laser having an output power of 5 mW. In case of the radiation is laser light the source of electromagnetic radiation 110 may, hence, generate a line laser pattern towards the sensor 130, and any object, such as a rope 150, therebetween.

The elevator rope monitoring device also comprises at least one sensor 130 suitable for detecting the electromagnetic radiation used in the elevator rope monitoring device. Advantageously, the at least one sensor 130 is selected so that a shadow cast by a rope 150 under monitoring fits entirely in a detection area of the sensor 130 in response to a radiation. However, in some example embodiments it may be arranged that only one edge of the rope 150 is monitored, or it may be arranged that a shadow of one edge of the rope 150 is detected by one sensor 130 and the shadow of the other edge of the rope 150 is detected by another sensor 130. According to still further example embodiment the sensor 130 may be selected so that it is selected, by size, so that shadows of a plurality of monitored ropes 150 fit in the detection area of the sensor 130 and the analysis of the conditions of the sensors 130 may be arranged separately through signal processing.

FIG. 5 schematically illustrates an example of a sensor side of the elevator rope monitoring device. The sensor side may be implemented so that at least one sensor 130 may be mounted on a circuit board 510 comprising necessary hardware and software components for controlling an operation of the at least one sensor 130 in such a way that the sensor 130 may detect radiation and data generated at least in accordance with the received radiation may be read from the sensor 130. According to some embodiments the at least one sensor 130 may be protected with a window 520 e.g. made of glass. In addition, in some embodiments the window 520 may be protected with a protection cover or with a number of detachable plastic protecting films in order to prevent dirt to end up on the window 520, or on the sensor 130, and/or to allow a removal of the dirt from the window 520, or the sensor 130, e.g. by detaching a plastic protecting film from the window 520. Hence, the implementation of the protection cover and/or the detachable plastic protecting films may correspond to ones discussed in the context of the source of electromagnetic radiation 110.

An applicable sensor 130 may be a so-called linear photosensitive array which may refer to a sensor comprising photo sensing elements in one row forming, hence, a pixel row. Such a sensor 130 has an advantage that it may be read in a fast way. However, other sensor implementations may also be applied to, such as sensors comprising sensing elements in a wider area than just in one row.

As discussed, the source of electromagnetic radiation 110 of the elevator rope monitoring device and the sensor 130 of the elevator rope monitoring device are mutually positioned, with respect to each other, so that the at least one elevator rope 150 under monitoring may be arranged to travel between the source 110 and the sensor 130 and the orientation of the rope 150 in the elevator rope monitoring device is such that at least portion of a shadow of the rope 150 projects on the sensor 130, and, hence, a portion of the radiation passes the rope 150 and reaches the sensor 130 directly.

Next, at least some aspects of the present invention are now described by introducing aspects relating to an analysis of data obtained from at least one sensor 130. First, data generated in response to a provision of electromagnetic radiation by a source of electromagnetic radiation 110 may be read out from sensor 130, i.e. from data storing entities, such as pixels of the sensor.

Depending on the implementation the reading of the data from the sensor 130 may be arranged so that the reading of data from the pixels is performed simultaneously from the sensor 130 and post-processing of the data for determining one or more parameters, such as a rope width from data, may be initiated by analyzing the measurement data so that the analysis is started from the measurement data obtained, i.e. read, from at least one outmost pixel, preferably from both outmost pixels residing at both ends of the sensor 130 and continuing the analysis e.g. pixel-by-pixel to an inward direction towards a center pixel(s) of the sensor 130 i.e. to an inward direction of the pixels in the sensor 130. This kind of reading technique may be called as an outside-inside reading. A more preferred implementation in the context of the present invention, however, may be that the processing, or analyzing, of the measurement data obtained from the pixels simultaneously, i.e. at the same instant of time, may be arranged so that the measurement data obtained from center pixel(s) is processed, i.e. analyzed, first and the processing direction is outwards from the center i.e. towards the outmost pixels i.e. outward direction. This corresponds to a phenomenon that a shadow of the elevator rope generates data in the pixels residing in the center of the sensor and by reading outwards one or more edges may be detected. This kind of reading technique may be called as an inside-outside reading. The expression center pixels refer to those pixels which comprise data representing the shadow of the elevator rope 150. Typically, the implementation is such that the pixels experiencing the shadow of the elevator rope 150 have a value corresponding to black. Moreover, it may be arranged that at least some of the pixels are not read at all. For example, since at least one aim of the present invention may be to detect abnormalities in an elevator rope 150 through an establishment of a representation of the elevator rope 150 i.e. from an image representing a shadow of the rope 150 it may not be necessary to read all pixels representing a center of the rope 150 because detections with respect to the abnormalities are challenging to make from that data, and an edge area of the rope is more interesting. In this manner, i.e. by selecting a detection area from the sensor 130, it is possible to optimize the data to be read from the sensor 130 and to be analyzed by the control unit 140.

Regarding the reading of data from the sensor it is advantageous to read the pixels simultaneously as indicated in the foregoing description. The simultaneous reading of the pixels mitigates any impact of a vibration of the rope to the result of the monitored parameter, such as to the rope width. This may be important at least in some embodiments, since the ropes are always vibrating in a plane perpendicular to rope longitude axis, which otherwise could destroy an accuracy of the monitoring.

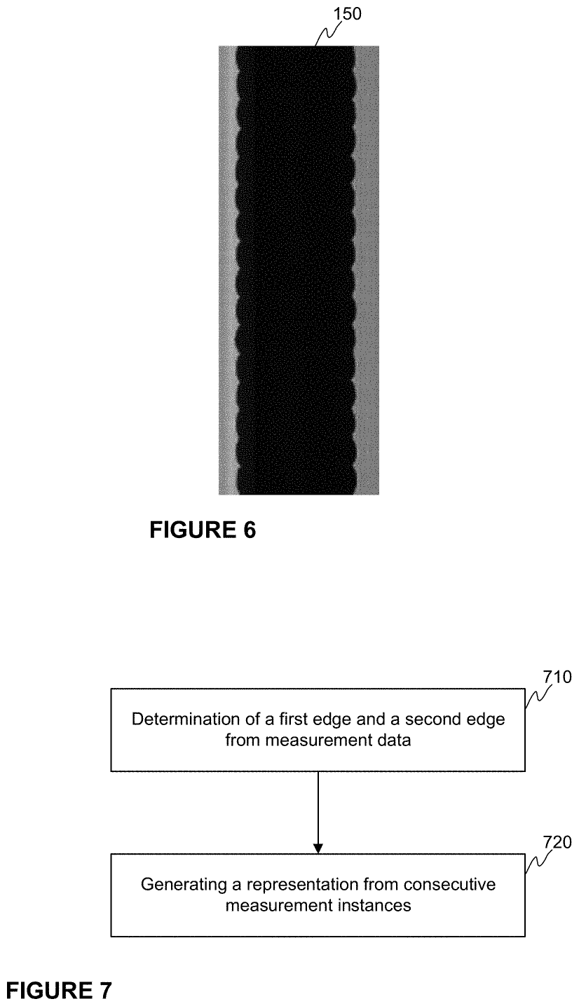

As described, by reading the sensor data, in a row-by-row, in response to moving of the rope 150 along its travel path, it is possible to generate a representation e.g. as an image representing the elevator rope 150 within an inspected length of the rope 150. FIG. 6 schematically illustrates an example of the generated representation from measurement data read from the sensor in consecutive reading phases which data is combined to generate the image of a rope silhouette. In other words, in response to a travel of the rope through a measurement position measurement data is generated at consecutive measurement instances in time. As schematically disclosed in FIG. 7 from the measurement data from an instant of time it may be determined 710 a first edge of the elevator rope 150 and a second edge of the elevator rope 150. The determination of the edges may e.g. be performed so that a value of a measurement data, e.g. obtained with post-processing of data, is compared to a reference value. The comparison indicates if the value derived from sensor data, i.e. from a plurality of pixels, correspond to a value of dark, such as black, or a value of light. More specifically, the value may represent a contrast value. The edge of the elevator rope 150 may be detected by recognizing when the measurement value of the measurement data changes rapidly from one value to another value. The generation 720 of the representation as disclosed in FIG. 6 may be performed so that in response the edges of the elevator rope 150 are detected from consecutive measurement data obtained at consecutive instances of time during the travel of the elevator rope 150 the measurement data i.e. data rows are combined together in accordance with the determined first edge of the elevator rope 150 and the determined second edge of the elevator rope 150. As a result, the representation of the elevator rope 150 may be generated along the length the elevator rope 150 traveled through the measurement point defined by the sensor 130. The representation of the elevator rope 150 may in various embodiments of the invention refer to a representation illustrating the rope as valleys and peaks (i.e. peak/valley representation) due to strand implementation of the elevator rope 150 typically applied in elevator solutions.

Further data analysis may be selected in accordance with a characteristic under monitoring. At least the following characteristics may be derived from the representation generated from the data received from the at least one sensor 130: rope width (cf. a diameter of the rope having a circular cross section), loose strand of the rope.

According to an embodiment of the invention the rope width may be determined by detecting a first edge of the rope 150 and a second edge of the rope from the sensor data as described above, and by determining of the width of the rope on the basis of pixels between the two edges. For example, a pixel size or a number of pixels with respect to a distance, such as per millimeter, may be known and based on that information the width may be determined. For the detection of the first and the second edge of the rope 150 rules may be determined and by applying them to the measurement data obtained from the sensor 130 the edges may be found. In response to the determination of the width of the rope, it may be compared to a comparison value defining a preferred width of the elevator rope 130, and a detection of abnormality may be performed if the values deviate from each other more than a predetermined limit. The width of the elevator rope 150 may be established for each measurement instant, i.e. from a measurement data of a data row, and e.g. statistical values of the elevator rope 150 may be derived from a plurality of values representing the width of the elevator rope 150, such as an average width of the elevator rope 150 or a width per pre-defined length.

In various embodiments of the invention in which the representation of the elevator rope 150 is the peak/valley representation the width of the elevator rope 150 may be determined from the peak/valley representation by determining a peak of the first edge and a peak of the second edge at a same measurement instant having a largest distance over a predetermined length of the elevator rope 150 as the width of the elevator rope 150. Alternatively or in addition, some statistical value may be determined e.g. from a plurality distance values determined from the peaks. Moreover, in some other embodiments the valley may be used as the determination point of the width.

In addition to above, further rules may be set for improving the determination of the rope width and/or to optimize computational power required for the calculation. For example, it may be determined some rules originating from possible location of the elevator rope 150 within the measurement installation. As a first non-limiting example it may be defined that the edge of the elevator rope 150 may not reside in a sensor gap if a plurality of sensors 130 are used in the measurement installation. Moreover, another rule may be set that the edge of the elevator rope 150 may not reside outside sensor edges. Alternatively or in addition, one or more threshold values may be set for detecting the edges of the elevator rope 150, such as adjusting the contrast value, or range, optimally to the environment.

According to a still further embodiment of the invention an analysis for detecting an abnormality of the rope 150 may comprise a loose strand analysis. The loose strand analysis, i.e. a detection of the loose strand, may comprise a detection of a number of loose strands by performing a Fourier transform, such as a short-time Fourier transform, of a measurement time with respect to a rope 150 width data. As the measurement data is represented in a frequency domain through the Fourier transform it is possible to detect frequency components, such as rising lower frequency components, in the frequency spectrogram, which may represent loose strands of the rope 150. For example, the control unit 140 may have access to a comparison value of a loose strand which is compared with value obtainable from the measurement data represented in the frequency domain. In response to a detection of a number of loose strands it may be decided, by applying predetermined rules, if the rope 150 is abnormal or not. For example, the comparison value, i.e. the rule, may define a gradient of the rising lower frequency component and/or an amplitude of it in order to determine if the frequency component in question represents the loose strand in the elevator rope 150 or not. In case one or more rising lower frequency components are identified, the control unit 150 may be arranged to generate an indication on a loose strand in the elevator rope 150, which may be judged to be a defect of the rope 150. For purpose of providing more insight to a number of lower frequency components typically elevator ropes have 6-9 outer strands and, thus, lower frequencies are 1/number of outer strands, 2/number of outer strands, 3/number of outer strands, and so on.

As is derivable from the description herein various embodiments of the invention allow detecting an abnormality of the elevator rope 150. With the present invention it is possible to establish sophisticated solution e.g. by illustrating the elevator rope 150 under monitoring as a function of a position in its length, i.e. lengthwise position of the rope 150. More specifically, outer dimensions of the elevator rope 150, i.e. the edge of the elevator rope 150, may be under interest. This kind of illustration may require that a position and/or a speed of the elevator rope 150 in relation to the sensor is known for all sensor readings. The speed information may e.g. be derived with motor encoder measurement. In view of this, also the strand peak/valley variation, as may e.g. be seen from FIG. 6 (the edge area of the rope 150), may be used as means for estimating measurement position as a function of rope run length. By means of this it is possible to establish the illustration of the elevator rope 150, and, hence, to determine the measurement position under interest, such as a position having abnormality, from the elevator rope 150.

By applying the above described non-limiting examples of an analysis of the rope 150 it is possible to detect abnormalities in the rope 150. Prior to performing the analysis itself the data obtained from the sensor 130 may be processed so that any interference e.g. originating from background light may be deducted from the data obtained from the sensor during the measurement. The amount of background light may e.g. be determined through a test measurement without performing a radiation with the source of electromagnetic radiation 110.

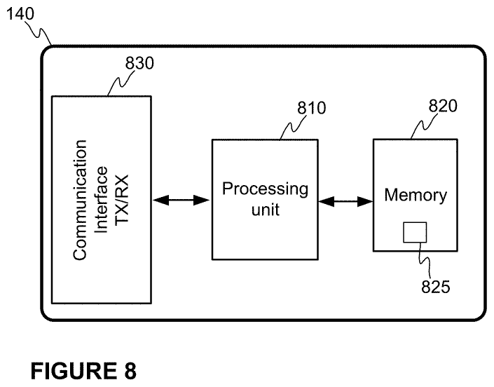

FIG. 8 schematically illustrates a control unit 140 according to an embodiment of the invention. The control unit 140 may comprise a processing unit 810, a memory 820 and a communication interface 830 among other entities. The processing unit 810, in turn, may comprise one or more processors arranged to implement one or more tasks for implementing at least part of the method steps as described. For example, the processing unit 810 may be arranged to control an operation of a source of electromagnetic radiation 110 and/or at least one sensor 130, and even an operation of the elevator, as well as any other entities of the present invention in the manner as described. The memory 820 may be arranged to store computer program code which, when executed by the processing unit 810, cause the control unit 140 to operate as described, such as performing the generation of the representation of the elevator rope 150 and any analysis and/or post-processing thereof. Moreover, the memory 820 may be arranged to store, as described, the reference value, and any other data. The communication interface 830 may be arranged to implement, e.g. under control of the processing unit 810, one or more communication protocols enabling the communication with the entities as described. The communication interface may comprise necessary hardware and software components for enabling e.g. wireless communication and/or communication in a wired manner. For sake of clarity the control unit 140 as schematically illustrated in FIG. 8 is a non-limiting example and other implementations may also be used. For example, the control unit 140 may be arranged as a distributed solution, such as a cloud computing solution, which receives the measurement data from a local entity, performs the method according to the present invention, and generates an indication on the outcome of the method, such as an indication representing a condition of the elevator rope 150. The indication, e.g. in a form of a data record, may e.g. be shown as a predetermined visual or acoustic method, or transmitted to a predetermined entity.

For sake of clarity it shall be understood that the control unit 140 performing the method as disclosed here may be distinct to the elevator rope monitoring device or part of it. Generally speaking, the control unit 140 may perform the generation of the representation as described.

As discussed, some aspects of the present invention relate to a method for monitoring an elevator rope 150 through a generation of a representation, or a value representing at least one characteristic, of the rope 150. In response to the receipt of the measurement data the control unit 140 may be arranged to generate the representation of the elevator rope 150 and perform any analysis thereto, and possibly to any other data representing at least one characteristic of the elevator rope 150. According to various embodiments of the invention the analysis may comprise an operation in which it is generated a representation of the elevator rope 150 as a function of an elevator rope 150 length traveled through the measurement installation. In other words, a representation of the elevator rope 150, as e.g. schematically depicted in FIG. 6, may be generated along the length of the elevator rope 150 which is moved through the at least one source of electromagnetic radiation 110 and the at least one sensor 120. The analysis, performed by the control unit 140, may be arranged to detect one or more occurrences in the representation of the elevator rope 150 generated from the measurement data received, such as by comparing one or more parameters of the representation to a comparison data. The comparison data may comprise at least one of the following: a comparison value for a width of the elevator rope 150; a comparison value for a data representing an edge of the elevator rope 150 (e.g. peak/valley value); a comparison value for a data representing a loose strand of the elevator rope 150. The method according to various embodiments of the present invention may comprise further operations, such as analysis, as described above.

Moreover, some aspects of the present invention may relate to a computer program product for monitoring an elevator rope 150 which, when executed by at least one processor, cause a control unit of the elevator rope monitoring device to perform the method as described. The computer program product may be stored in a non-transitory computer-readable medium, such as an applicable memory unit, accessible to the processor configured to execute the computer program product.

Some further aspects of the invention may relate to an elevator system comprising: an elevator rope monitoring device as described and at least one elevator rope 150 arranged to travel between at least one source of electromagnetic radiation 110 of the elevator rope monitoring device and at least one sensor 120 of the elevator rope monitoring device. Naturally, the elevator system may comprise further elements and entities as e.g. discussed in the description of FIG. 2. However, the present invention is not necessarily limited to a measurement data derivable with the measurement installation as described herein, but any measurement installation, or device, may be used to generate the corresponding measurement data in order to generate the representation, and to perform the analysis as described.

The solution according to the present invention enable a condition monitoring of elevator ropes with respect to at least some of the following aspects: a change in width of the rope e.g. caused by rope bends about pulleys or non-lubricated rope, a detection of one or more loose strands. The described solution is fast enough to be capable of inspecting the rope during normal usage or maintenance drive in high enough resolution. The conditioning monitoring of the elevator rope may be arranged to occur automatically (e.g. remotely over connectivity e.g. from cloud) or manually by a maintenance technician using a monitoring apparatus at the elevator site.

The specific examples provided in the description given above should not be construed as limiting the applicability and/or the interpretation of the appended claims. Lists and groups of examples provided in the description given above are not exhaustive unless otherwise explicitly stated.

1. A method for generating a representation of an elevator rope, the method comprising:
determining a first edge and a second edge of the elevator rope from measurement data obtained from consecutive measurement instances, instances; and
generating a representation of the elevator rope by combining the measurement data of the consecutive measurement instances in accordance with the determined first edge of the elevator rope and the determined second edge of the elevator rope.

2. The method of claim 1, wherein the measurement data is obtained simultaneously from all pixels of a sensor.

3. The method of claim 1, wherein the determination is performed by one of a following:
analyzing the measurement data by starting from the measurement data read from at least one pixel residing in a center of the sensor and continuing an analysis pixel-by-pixel to an outward direction of the pixels in the sensor; and
analyzing the measurement data by starting from the measurement data read from at least one pixel residing outmost of the sensor and continuing the analysis pixel-by-pixel to an inward direction of the pixels in the sensor.

4. The method of claim 1, wherein a generation of the representation of the elevator rope comprises a generation of a peak/valley representation of the elevator rope.

5. The method of claim 1, the method further comprising:
determining a width of the elevator rope based on a distance between the determined first edge of the elevator rope and the second edge of the elevator rope.

6. The method of claim 5, wherein the width of the elevator rope is determined from a peak/valley representation by determining a peak of the first edge and a peak of the second edge at a same measurement instant having a largest distance over a predetermined length of the elevator rope as the width of the elevator rope.

7. The method of claim 5, wherein the representation of the elevator rope is generated in a frequency domain by applying a Fourier transform of the measurement time with respect to width data.

8. The method of claim 7, the method further comprising:
identifying at least one rising lower frequency component from the representation of the elevator rope in the frequency domain; and
in response to an identification of at least one rising lower frequency component, generating an indication on at least one loose strand in the elevator rope.

9. The method of claim 4, the method further comprising:
estimating a measurement position of the elevator rope on a basis of a peak/valley representation of the elevator rope.

10. A control unit for generating a representation of an elevator rope, the control unit comprising:
at least one processor;
at least one memory including computer program code;
the at least one memory and the computer program code configured to, with the at least one processor, cause the control unit to perform:
determine a first edge and a second edge of the elevator rope from measurement data obtained from consecutive measurement instances; and
generate a representation of the elevator rope by combining the measurement data of the consecutive measurement instances in accordance with the determined first edge of the elevator rope and the determined second edge of the elevator rope.

11. The control unit of claim 10, wherein the control unit is arranged to obtain the measurement data simultaneously from all pixels of a sensor.

12. The control unit of the claim 10, wherein the control unit is arranged to perform the determination by one of a following:
analyzing the measurement data by starting from the measurement data read from at least one pixel residing in a center of the sensor and continuing an analysis pixel-by-pixel to an outward direction of the pixels in the sensor; and
analyzing the measurement data by starting from the measurement data read from at least one pixel residing outmost of the sensor and continuing the analysis pixel-by-pixel to an inward direction of the pixels in the sensor.

13. The control unit of claim 10, wherein the control unit is arranged to generate the representation of the elevator rope as a peak/valley representation of the elevator rope.

14. The control unit of claim 10, the control unit further caused to perform:
determine a width of the elevator rope based on a distance between the determined first edge of the elevator rope and the second edge of the elevator rope.

15. The control unit of claim 14, wherein the control unit is arranged to determine the width of the elevator rope from a peak/valley representation by determining a peak of the first edge and a peak of the second edge at a same measurement instant having a largest distance over a predetermined length of the elevator rope as the width of the elevator rope.

16. The control unit of claim 14, wherein the control unit is arranged to generate a representation of the elevator rope in a frequency domain by applying a Fourier transform of the measurement time with respect to width data.

17. The control unit of claim 16, the control unit further caused to perform:
identify at least one rising lower frequency component from the representation of the elevator rope in the frequency domain; and
in response to an identification of at least one rising lower frequency component generate an indication on a loose strand in the elevator rope.

18. The control unit of claim 13, the control unit further caused to perform:
estimate a measurement position of the elevator rope on a basis of a peak/valley representation of the elevator rope.

19. A computer program product embodied on a non-transitory computer readable medium for generating a representation of an elevator rope which, when executed by at least one processor, causes a control unit to perform the method according to claim 1.

20. The method of claim 2, wherein the determination is performed by one of a following:
analyzing the measurement data by starting from the measurement data read from at least one pixel residing in a center of the sensor and continuing an analysis pixel-by-pixel to an outward direction of the pixels in the sensor; and
analyzing the measurement data by starting from the measurement data read from at least one pixel residing outmost of the sensor and continuing the analysis pixel-by-pixel to an inward direction of the pixels in the sensor.
